(19) United States
(12) Patent Application Publication
(10) Pub. No.: US 2026/0342064 A1
(43) Pub. Date: Oct. 29, 2026

(54) STUD NOTCH

(71) Applicant: Greg Otto, Los Angeles, CA (US)

(72) Inventor: Greg Otto, Los Angeles, CA (US)

(21) Appl. No.: 19/645,246

(22) Filed: Apr. 12, 2026

Related U.S. Application Data
(60) Provisional application No. 63/793,463, filed on Apr. 23, 2025.

(51) Int. Cl. H02G 3/22; E04B 2/74

(52) U.S. Cl. CPC H02G 3/22; E04B 2002/7488

(57) ABSTRACT

Described herein are a wall framing system including a set of connected framing elements, the elements having a series of exterior notches dimensioned to accommodate modular electrical components such as wiring. The framing elements are chosen from studs, top plates, bottom plates, or any framing element requiring horizontal or vertical electrical routing. Also described are a method for installing an electrical system or components thereof, including inserting prefabricated electrical system or circuit components such as wires into the exterior notches of the framing elements of the wall framing system of the disclosure and a modular home or building comprising the wall framing system of the disclosure.

### CROSS-REFERENCE TO RELATED APPLICATIONS

The present application relies on the disclosure of and claims priority to and the benefit of the filing date of U.S. Provisional Application No. 63/793,463, filed Apr. 23, 2025, the disclosure of which is hereby incorporated by reference herein in its entirety.

### FIELD

The present disclosure is directed to the field of construction, and in particular, modular construction techniques and practices for electrical installations.

### BACKGROUND

Factory built homes have remained unpopular due to a number of factors including a lack in flexibility or versatility in design options often resulting in unattractive, box-like architectures that are inferior to homes built on site. There is a need for improvement in industrial home construction technology.

### SUMMARY

In general, in a first aspect, the disclosure features a wall framing system including a set of connected framing elements, the elements having a series of exterior notches dimensioned to accommodate wiring between modular electrical components.

In general, in a second aspect, the disclosure features a method for installing an electrical system or components thereof, including inserting prefabricated electrical system or circuit components such as wires into the exterior notches of the framing elements of the wall framing system.

In general, in a third aspect, the disclosure features a method including first assembling an electrical circuit including modular electrical components connected by wiring and then installing the assembled electrical circuit in the wall framing system by routing the wiring through the exterior notches of the wall framing system.

In general, in a fourth aspect, the disclosure features a modular home or building including the wall framing system of the disclosure.

Features of the wall framing systems, methods, and modular homes or buildings can include the following. The framing elements can be chosen from studs, top plates, bottom plates, or any framing element requiring horizontal or vertical electrical routing. The modular electrical components can be chosen from switches, outlets, junction boxes, subpanels, and main panels. When the framing elements are studs, the exterior notches can be aligned horizontally. The modular homes or buildings can include an electrical circuit installed in the wall framing system through routing wiring through the exterior notches of the wall framing system. The assembling and installing can be performed off-site from a construction site.

It should be understood that the wall framing systems, methods, and modular homes or buildings are not to be considered limitations on the invention defined by the claims. The featured wall framing systems, methods, and modular homes or buildings can be implemented in one or more ways using one or more features depicted in the drawings, described in the detailed description, and set forth in the claims.

### BRIEF DESCRIPTION OF THE DRAWINGS

The accompanying drawings illustrate certain aspects and principles of the implementations set forth, and should not be construed as limiting.

FIGS. 1A and 1B are diagrams showing examples of a top plate (FIG. 1A) and stud (FIG. 1B) with exterior notches.

FIGS. 1C and 1D are tables with examples of top plate (FIG. 1C) and stud (FIG. 1D) exterior notch specifications.

FIG. 1E is a set of tables and diagrams showing additional examples of top plate and stud notch specifications and examples.

FIG. 2 is a diagram showing examples of framing notches for electrical circuit installation.

FIGS. 3A-3C are images showing stud notch examples.

FIG. 3D is an image showing top plate notch examples.

FIG. 4 is a diagram of a wall elevation according to one implementation.

FIG. 5 is a diagram of a wall elevation sub-assembly according to one implementation.

FIG. 6 is a diagram of a wall plan according to one implementation.

FIG. 7 is an image of an electrical circuit installed on a wall panel according to one implementation, where the electrical circuit leaves the wall vertically through a notch in the top plate.

FIG. 8 is a diagram of an electrical sub-assembly according to one implementation, where wiring components of the electrical circuit are threaded through notches in the studs.

### DETAILED DESCRIPTION

Reference will now be made in detail to various illustrative implementations. It is to be understood that the following discussion of the implementations is not intended to be limiting.

### System and Method for Mass Customization and Industrialization of Residential Construction via Productized Components

The disclosure generally relates to a system and method for enabling mass-customizable residential construction by standardizing and productizing subcomponents. The system and method include a digital engine that ingests builder-specific floor plans and decomposes them into standardized construction products, a rules-based generative and computational design system that permits unique configurations of these elements while maintaining structural and code compliance, and a product strategy where both the individual subcomponents and their assembled configurations (e.g., sub-assemblies, assemblies (wall panels), full housing units) are treated as products that can be certified nationally, thereby enabling regulatory approval at both the part and system level.

The result is a scalable framework for manufacturing highly variable home designs using a consistent, factory-built component library.

How it differs from the status quo (with clear differentiators):

The construction industry has historically failed to adopt industrialized methods due to the perceived rigidity of prefabrication and the need for architectural customization. The disclosure addresses that by Micro-Standardization Instead of Macro-Standardization. Existing systems often rely on standardization by large 3D volumetric modules (often as big as 9′×14′×70'). The system of the present disclosure standardizes at the subcomponent level (electrical assembly, plumbing assembly, etc.) enabling greater design flexibility when aggregated into 2D panels.

With respect to plan-ingestion and component translation, architectural floor plans are interpreted through the digital engine that translates architectural intent into manufacturable, repeatable parts.

With respect to rules-based recombination engine, a computational design tool governs how components are assembled and integrated, ensuring structural and regulatory integrity while allowing custom layouts.

Another feature includes certifiable component and assembly framework, where the system supports product certification (e.g., UL, ICC) at both the component and aggregate level, allowing for streamlined permitting and inspection processes across multiple jurisdictions.

Value provided by the systems and methods of the disclosure includes design flexibility with manufacturing efficiency: builders and customers retain architectural freedom while benefitting from cost and speed advantages typical of industrialization. This industrialization enables an automotive-like supply chain: similar to automobile assembly, components (e.g., HVAC modules, plumbing packs, structural frames) can be produced independently and integrated during final assembly. The systems and methods also provide a platform for continuous product optimization: standardization at the component level enables continuous improvement in materials, methods, and tolerances, driving down cost and improving housing quality at scale.

In summary, the systems and methods of the disclosure enable scalable mass customization of residential structures by decomposing architectural designs into standardized, certifiable subcomponents, configurable via a computational design engine. The approach combines digital design interpretation, component-level productization, and rules-based configuration logic to allow for the industrialized manufacture of architecturally diverse, code-compliant homes.

The present inventors have created systems and methods that let people design homes the way they like them—any shape, style, or size—and still build them quickly in a factory. Such systems and methods provide an application or program or software that works by breaking every house design into small, repeatable parts (like Lego bricks) that can be put together in many different ways. The software can take any builder's floor plan and turn it into a set of these building blocks, ready to be made in a factory.

Most factory-built homes today are big boxy shapes because it's easier to build that way. But most people don't want to live in a box—they want a home with a nice roof, cozy porch, or custom touches. That's why factory homes haven't caught on.

The present disclosure addresses this by:
Making small, easy-to-build parts that fit together in lots of ways, not just boxes.
Using software that understands how a home should look and figures out how to build it from standard parts.
Treating each small part (like a piece of a wall or a plumbing unit) as a real product that meets building rules—so cities are more likely to approve it.
   3. Why this matters:
People can have the home they want: You don't have to settle for boring designs just to stay on budget.
Builders can work faster and cheaper: Like car makers who get parts from different places and put them together on one big line, this lets home builders do the same.
The parts keep improving: Because the pieces are always the same, they can be made better, cheaper, and stronger over time.

In summary, the present inventors have developed an innovation that builds homes like Lego sets: lots of little parts that fit together in many ways. The system helps turn any home design into a set of parts that can be made in a factory. That means homes can still be beautiful and personal—but they'll be faster to build, more affordable, and easier to approve across the country.

### Executive Summary: Master System Design for Standardized Panel-Based Construction

At the core of the innovation is a belief that architectural flexibility is enabled by micro-level standardization, much like LEGO® bricks. The disclosed system breaks down the construction of a house into modular, manufacturable components called panels, which can represent walls, floors, or roofs. This principle applies universally across trades and forms the foundation for nearly every product innovation or patent pursued.

Key Principles of the System:

### 1. Panel-Based Modularization:

A home is divided into standardized panels that can be manufactured off-site. While the function of each panel (wall, floor, or roof) varies, the production methodology remains uniform—except for floors, which may require unique handling due to their scale.

### 2. Trade Sub-Assemblies for Added Value:

Panels become more than structural shells—they serve as carriers for trade-specific sub-assemblies (e.g., electrical, plumbing, HVAC). This builds complexity and value into the panel without complicating the main production line.

### 3. Standardized Sub-Assembly Design:

Sub-assemblies are value-added component clusters exhibiting high repetition and standardization. They reduce complexity on the main production line by shifting intricate work to batched or mass-produced modules that can be fabricated independently.

### 4. Indexing for Geometric Integration:

Each sub-assembly is geometrically indexed—either with a self-contained frame or a defined location within the panel frame. This ensures precise placement, rapid field integration, and consistent downstream routing.

5. Aggregation into 3D Assemblies:

Panels are not the endpoint. They can be aggregated into 3D volumetric assemblies (e.g., trusses, pods), providing a scalable pathway from flat-pack components to volumetric or hybrid prefab systems.

### Why It Matters:

This system enables scalable mass production of custom homes while preserving architectural flexibility. By anchoring innovation in standardization at the sub-panel level, a broad design vocabulary is unlocked across trades and product lines.

### Example 1: Standardized Electrical Circuit Design

### 1. The Innovation:

A modular, repeatable electrical system for residential construction that breaks a home's wiring into pre-built, home-run circuit components. Each circuit includes a single junction box (acting like a mini sub-panel), standardized wire lengths, and is designed for offsite installation without routing wires through studs. The result is a “plug-and-play” system that replaces traditional, manual in-field electrical wiring installation.

2. How it differs from the status quo (with clear differentiators):

Traditionally, residential electrical wiring is installed on-site by skilled electricians. They drill holes through studs, manually route wires to switches and outlets, and terminate each run at the main panel—an inconsistent, labor-intensive process. In contrast, the modular electrical system transforms this work into a repeatable manufacturing process by standardizing and componentizing circuits.

Key differentiators include:
Componentized Circuits with Home-Run Wiring:

Each circuit is pre-built as a discrete unit with a dedicated wire run from the junction box back to the main electrical panel—no mid-line splicing, no in-wall routing.
Single Junction Box per Circuit:

All connections for a given circuit are consolidated into a single, pre-configured junction box, functioning similarly to a sub-panel. This simplifies troubleshooting and installation while reducing field variability.
Standardized Wire Lengths and Layouts:

Circuits are designed with known, repeatable wire lengths, enabling mass production in a factory setting. These lengths are tailored to common layouts, making them usable across an infinite number of home designs.
No Need to Drill Through Studs:

The system can be installed from outside the stud bay, eliminating the need to route wires through drilled holes—see “Notch patent application” for more details.
Labor-Simplifying Design:

Like the plumbing assemblies, this approach enables lower-skill labor to complete more of the work faster, cheaper, and with fewer errors offsite.

### 3. Value Provided by the Innovation:

Mass Production & Repeatability: Reduces variation and labor cost by turning complex electrical systems into predictable, repeatable modules.
Accelerated Installation: Allows unskilled labor to install major portions of the electrical system offsite, decreasing overall build time and cost.
Floorplan and Architectural Flexibility: Standardized design of the wiring “components” unlocks unlimited freedom in the structure design
Cross-Compatibility with Prefab Models: Aligns with offsite and modular construction trends, supporting scalable deployment across multiple home builds.

### 4. Summary:

This innovation simplifies residential wiring by transforming in-field electrical rough-in into a modular, offsite process. Using home-run circuits with standardized lengths, a single junction box per circuit, and no in-stud routing, the system enables faster, safer, and more scalable electrical installations—reducing reliance on skilled labor and aligning with the demands of modern prefabricated construction.

### Example 2: Stud Notch for Electrical Circuit Installation

### 1. The Innovation:

A notching system and method for enabling full electrical circuit prefabrication in offsite construction. The system involves a purpose-built exterior and linear notch applied to framing members (e.g., studs, top plates, bottom plates) that allows complete, pre-wired electrical subcomponents to be laid into the framing prior to panelization—eliminating the need for through-stud drilling and enabling componentized circuits to be installed by unskilled labor.

### 2. How It Differs From the Status Quo (With Clear Differentiators):

In traditional construction, electricians must manually drill holes through every stud and plate to route wire throughout the house. This process is time-consuming, labor-intensive, and limits the size of what can be passed through a wall cavity. It prevents the installation of larger electrical components (such as switches, plugs, or junction boxes) as part of a single, continuous pre-wired circuit.

The system of the disclosure solves this by introducing a notching technique that enables circuit installation from the outside of framing members, rather than through them.

Key Differentiators Include:
Exterior & Linear Notch Geometry:

A precisely designed notch—linear in form and applied to the exterior of studs or plates—accommodates electrical wires and subcomponents without violating structural codes. Variations include single and double relief profiles.
Full Circuit Componentization:

The notch enables installation of entire, pre-wired circuits (including boxes, switches, and terminations) into wall, floor, or roof panels before assembly, allowing these circuits to be mass-produced and installed without needing to be routed through drilled holes in the framing.
Preserved Structural Integrity:

The notch dimensions (depth and height) are engineered to avoid compromising the structural capacity of the framing member, unlike large, drilled holes.
Flexible Placement:

Can be used in studs, top plates, bottom plates, or any framing element requiring horizontal or vertical electrical routing—without modifying the core framing layout.
Labor Simplification:

Enables installation by unskilled workers—since no wire pulling, cutting, or splicing is required in the field. Installers simply embed the prefabricated “electric Lego” modules into the panels following pre-designed guides.

### 3. Value Provided by the Innovation:

Offsite Circuit Prefabrication:

Enables full circuits—including boxes, wires, and terminations—to be built in a factory setting, reducing cost, error, and labor time.
Installation Without Skilled Labor:

Modules can be installed by lower-skilled workers using guided templates, dramatically reducing the need for licensed electricians on site.
Standardization with Flexibility:

Allows for highly standardized components that can be combined into flexible, architecturally diverse layouts—scaling from tract homes to custom builds.
Elimination of Drilled Wire Paths:

By removing the need for hole drilling, the system improves construction speed, safety, and overall build consistency.
Structural Compliance:

The notch is engineered to maintain code-compliant structural performance, removing concerns about weakening framing elements.

### 4. Summary:

This innovation replaces the need for drilling through framing members by introducing a structurally safe, exterior notch that allows entire prefabricated electrical circuits—wires, boxes, and all—to be embedded into panels offsite. The result is a labor-saving, factory-scalable system that enables “plug-and-play” installation of full residential wiring circuits with unmatched speed, consistency, and design flexibility. The notch allows for completed circuits, manufactured as sub-assemblies, to be laid into the completed panel. In traditional construction, the wire is pulled through drilled holes and then the boxes are installed and made up. This innovation allows circuits to be made in pre-production ahead of completing walls, greatly increasing productivity.

Implementations of electrical circuit modules and their implementation in the system of notches are shown in the following figures.

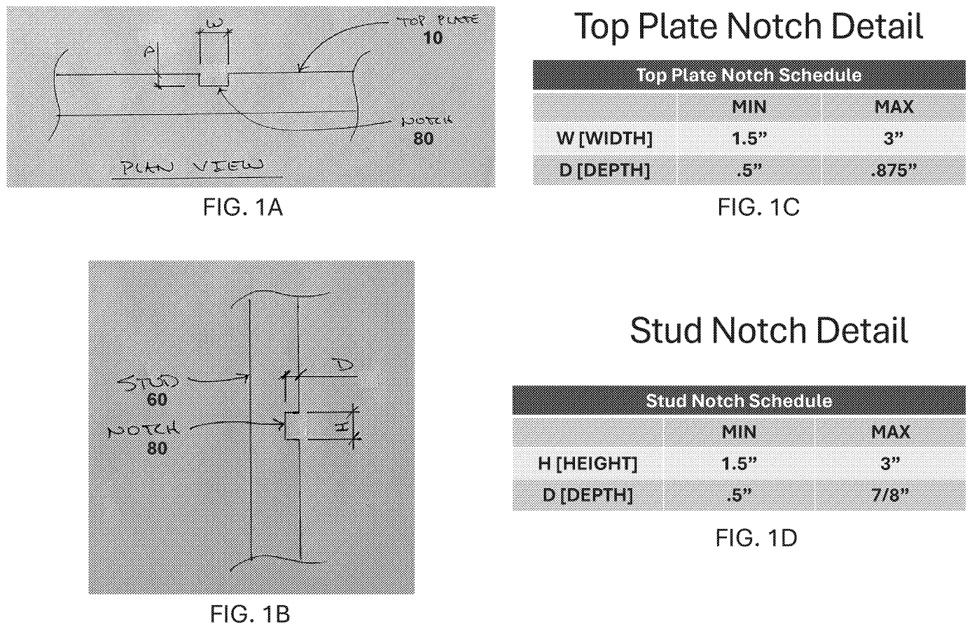

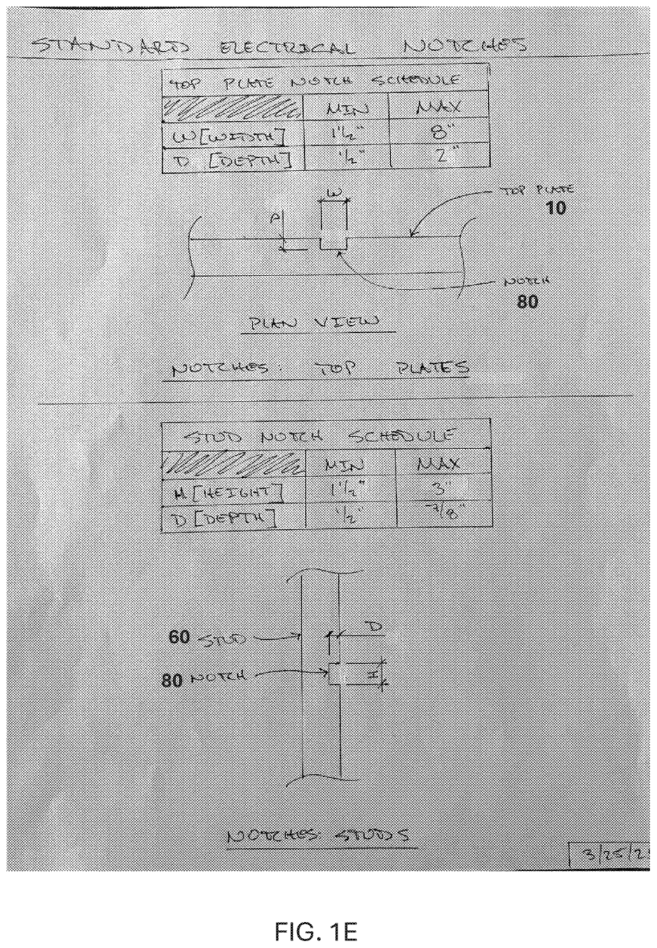

FIGS. 1A and 1B are diagrams showing examples of a top plate 10 (FIG. 1A) and stud 60 (FIG. 1B) with exterior notches 80 cut into their surfaces, where dimension of width (or height) and depth are called out.

FIGS. 1C and 1D are tables with examples of top plate (FIG. 1C) and stud (FIG. 1D) exterior notch specifications. Minimum and maximum width (or height) and depth are shown.

FIG. 1E is a set of tables and diagrams showing additional examples and specifications of exterior notches 80 for top plate 10 and stud 60.

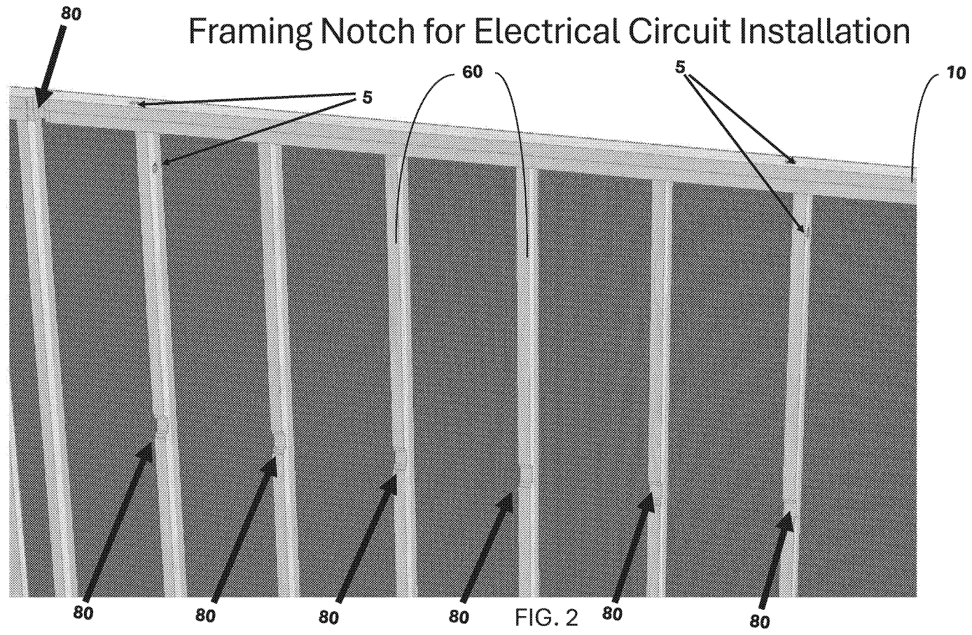

FIG. 2 is a diagram showing examples of exterior framing notches 80 for electrical circuit installation. The framing notches 80 near the bottom of the figure are aligned and located at the same heights of parallel studs 60 for routing wiring for electrical circuit installation. The notch 80 at the top left is located within the top plate 10. The traditional holes 5 drilled within the top plate and studs for wire routing are shown at the top.

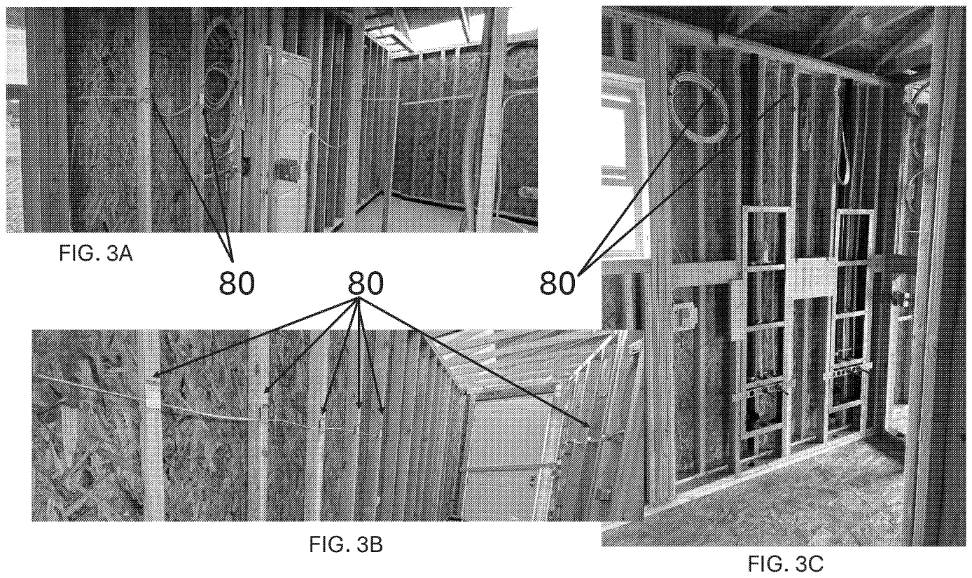

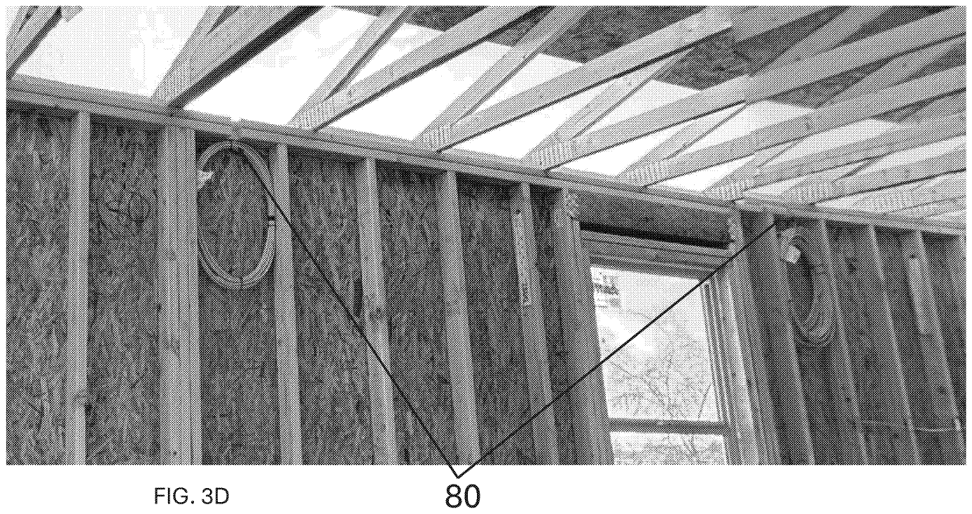

FIGS. 3A-3C are images showing exterior stud notch examples 80 in a recently installed wall panel. A wire is run through the notches and plates are installed over them to secure the wire.

FIG. 3D is an image showing exterior top plate notch examples 80 in a recently installed wall panel.

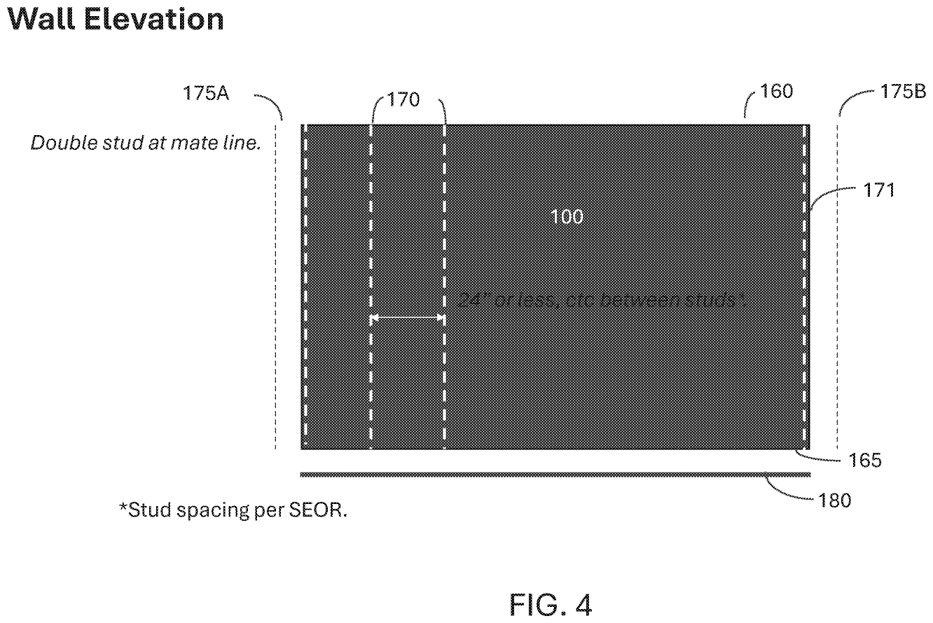

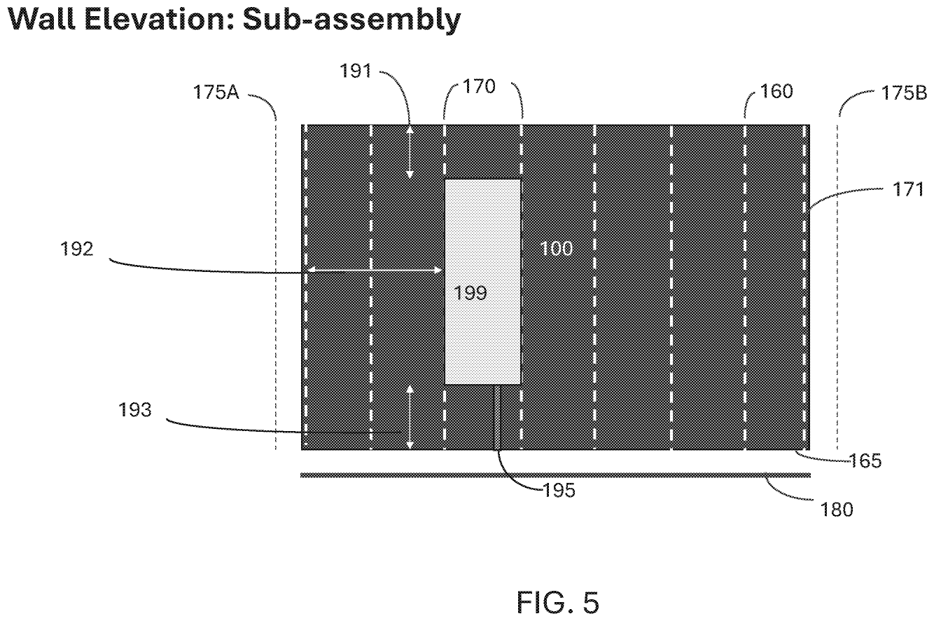

FIGS. 4 and 5 are diagrams of a wall elevation according to one implementation. A wall panel is composed of 2×framing and may include value added sub-assemblies. Exterior walls will be sheathed and insulated. A wall panel 100 is shown between the top plate 160 and the bottom plate 165. The position of studs 170 is also shown, as well as mate lines 175A and 175B. The mate line stud 171 is shown at the far right, and at the bottom is a shim leveling plate 180 to level against slab. FIG. 5 is a diagram of the same wall elevation with sub-assembly inserted, which shows the location of a cassette or insert 199 indexed horizontally by studs 192 and indexed 191 from the top plate 160, and indexed 193 from the bottom plate 165 by a setting block 195. Sub-assembly (insert 199) is indexed relative to top 160 and bottom 165 plates. The setting block 195 fixes location at set. Mounting tabs screw to face of studs 170, which index left/right location. Such wall elevations can be used for construction of a building.

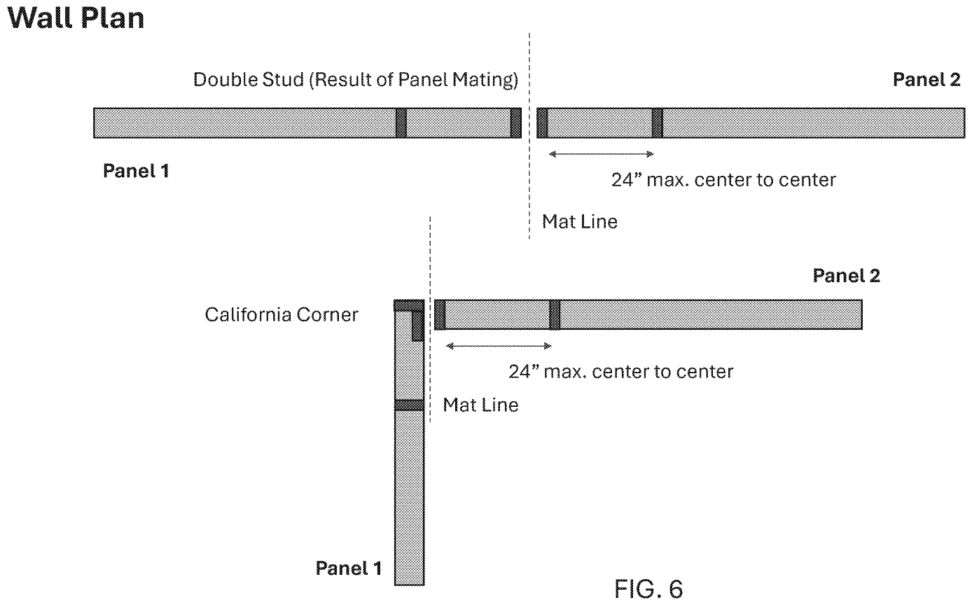

FIG. 6 is a diagram of a wall plan according to one implementation. At the top are two wall panels joined end to end. At the bottom, two panels are shown joined together perpendicularly at a corner. The position of studs is also shown. Such wall plans can be used for construction of a building.

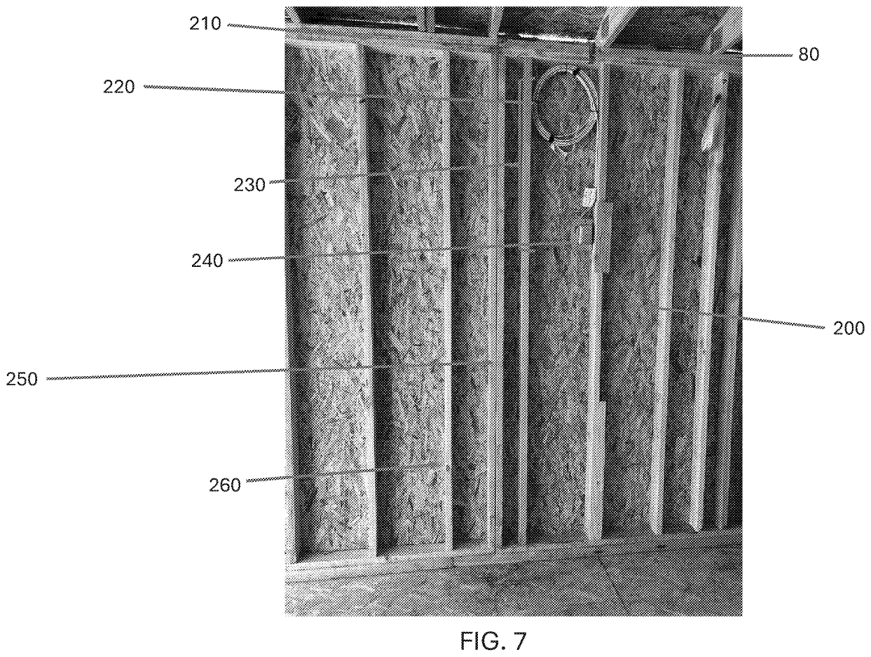

FIG. 7 is an image of an electrical circuit installed on a wall panel 200 according to one implementation. Shown from top to bottom are a top plate 210, a whip 220, the circuit (complete assembly) 230, and a J Box (outlet) 240. The framed (wood) panel joint 250 and stud 260 are also called out. The whip 220 gets pulled to the sub-panel (not shown), located within one quadrant of the home. From the sub panel, the home run (not shown) is pulled to the main panel (not shown). All circuits pull (leave) the framed (wood) panel vertically, feeding through a notch 80 cut into an exterior surface of the top plate 210.

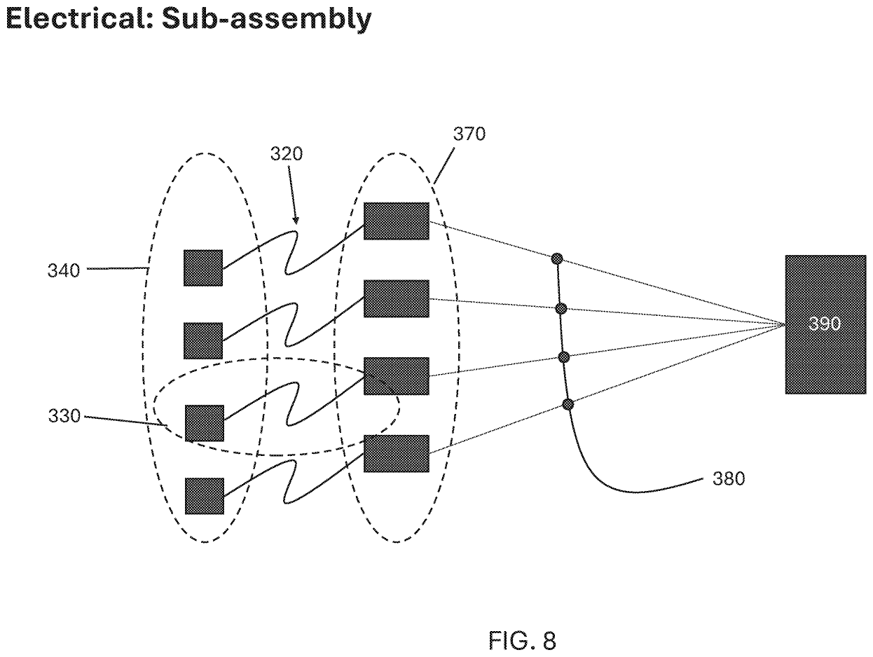

FIG. 8 is a diagram of an electrical sub-assembly according to one implementation. The electrical subassembly includes the J Boxes 340 that can be a switch or outlet that feeds into the sub panels (J Boxes or equivalent) 370 by the whips (pig tails) 320 to form a circuit 330. The number of circuits can be as many circuits as required per quadrant. The subpanels 370 feed into the power center (main panel) 390 by home runs 380 which can also be multi-runs. The whips 320 and home runs 380 of the electrical sub-assembly can be routed through wall panels using the system of stud notches of the disclosure.

While embodiments in the drawings have demonstrated rectangular exterior notches, other implementations may employ notches of other shapes, such as semicircular-shaped or triangular-shaped exterior notches. The notches are cut into a surface of wood members serving as top plates, studs, and other frame components using known woodworking equipment and techniques. The wood members are assembled into frames, and the various electrical circuits and components are installed in the frames either offsite from the construction site or on-site, using the notches to route the wiring. The notches can be covered with plates or other coverings to keep the wiring secure. The frames can be assembled together onsite to build a modular home or building.

The present disclosure has described particular implementations having various features. In light of the disclosure provided above, it will be apparent to those skilled in the art that various modifications and variations can be made without departing from the scope or spirit of the disclosure. One skilled in the art will recognize that the disclosed features may be used singularly, in any combination, or omitted based on the requirements and specifications of a given application or design. When an implementation refers to “comprising” certain features, it is to be understood that the implementations can alternatively “consist of” or “consist essentially of” any one or more of the features. Other implementations will be apparent to those skilled in the art from consideration of the specification and practice of the disclosure.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the disclosure fall within the scope of the disclosure. Further, all of the references cited in this disclosure including patents, published applications, and non-patent literature are each individually incorporated by reference herein in their entireties and as such are intended to provide an efficient way of supplementing the enabling disclosure as well as provide background detailing the level of ordinary skill in the art.

1. A wall framing system comprising a set of connected framing elements, the elements having a series of exterior notches dimensioned to accommodate wiring between modular electrical components.

2. The wall framing system of claim 1, wherein the framing elements are chosen from studs, top plates, bottom plates, or any framing element requiring horizontal or vertical electrical routing.

3. The wall framing system of claim 1, wherein the modular electrical components are chosen from switches, outlets, junction boxes, subpanels, and main panels.

4. The wall framing system of claim 2, wherein the framing elements are studs wherein the exterior notches are aligned horizontally.

5. The wall framing system of claim 2, wherein the framing elements are top plates.

6. A method for installing an electrical system or components thereof, comprising inserting prefabricated electrical system or circuit components such as wires into the exterior notches of the framing elements of the wall framing system of claim 1.

7. A method comprising first assembling an electrical circuit comprising modular electrical components connected by wiring and then installing the assembled electrical circuit in the wall framing system of claim 1 by routing the wiring through the exterior notches of the wall framing system.

8. The method of claim 7, wherein the modular electrical components are chosen from switches, outlets, junction boxes, subpanels, and main panels.

9. The method of claim 7, wherein the assembling and installing are performed off-site from a construction site.

10. A modular home or building comprising the wall framing system of claim 1.

11. The modular home or building of claim 10, further comprising an electrical circuit installed in the wall framing system with wiring routed through the exterior notches of the wall framing system.
